(19) United States
(12) Patent Application Publication
(10) Pub. No.: US 2016/0358541 A1
(43) Pub. Date: Dec. 8, 2016

(54) DISPLAY APPARATUS AND METHOD FOR DRIVING THE SAME

(71) Applicant: BOE TECHNOLOGY GROUP CO., LTD., Beijing (CN)

(72) Inventors: Yanzhao Li, Beijing (CN); Long Wang, Beijing (CN); Li Zhou, Beijing (CN); Feng Jiang, Beijing (CN); Han-Jun Park, Beijing (CN); Chung-Chun Lee, Beijing (CN)

(21) Appl. No.: 15/024,069

(22) PCT Filed: Jul. 22, 2015
(86) PCT No.: PCT/CN2015/084777

§ 371 Date: Mar. 23, 2016

(30) Foreign Application Priority Data
Feb. 16, 2015 (CN) 201510084820.8

(51) Int. Cl. G09G 3/3208; G02F 1/137; G06F 3/041; G09F 9/33

(52) U.S. Cl. CPC G09G 3/3208; G09F 9/33; G02F 1/137; G06F 3/041; G09G 2300/0452; G09G 2320/0646

(57) ABSTRACT

The present disclosure provides a display apparatus and a method for driving the same, which relates to a display field and solves an issue of difficulty of implementing a high resolution by changing the substrate in the present display panel. The display apparatus comprises a display panel, an light modulator, a first driving module and second driving module, wherein the display panel comprises a plurality of pixels including n virtual pixels; the light modulator is provided at a light outputting side of the display panel and comprises a plurality of light modulation units corresponding to the pixels, and the light modulation unit comprises n light modulation areas corresponding to the virtual pixels; and one frame of image comprises n pieces of sub-frame images; the first driving module is configured to drive the display panel to display n continuous sub-frame images in one frame of image in turn; the second driving module is configured to drive the n^{th} light modulation area of the light modulation unit to be a light transmitted region in the n^{th} sub-frame image in turn, and to drive the remaining (n-1) light modulation areas to be a light shielding region, in which N is a positive integer larger than or equal to 2.

### CROSS-REFERENCE TO RELATED APPLICATION(S)

This application claims priority to Chinese Application No. 201510084820.8, entitled “DISPLAY APPARATUS AND METHOD FOR DRIVING THE SAME” and filed on Feb. 16, 2015, the contents of which are incorporated herein by reference in its entirety.

### TECHNICAL FIELD

The present disclosure relates to the display field, and particularly to a display apparatus and a method for driving the same.

### BACKGROUND

In a field of electronic display, the continuously seek object is a more clear image, which is mainly implemented by improving a display resolution. The display resolution is a precision for displaying an image and represents the numbers of pixels which can be displayed in the display. The more the pixels the display can display is, the finer the image is, and the more the information which can be displayed in the same screen area are.

An OLED (Organic Light-Emitting Diode) display panel is prized for its properties of self-light-emitting, being manufactured from an organic material, capable of being cured and folded, and the like. The light emitting principle of the OLED display panel is shown as follows: an organic light-emitting layer is deposited between two electrodes; when a voltage is applied across the two electrodes, holes and electrons are injected into the organic light-emitting layer to form stimulated element and the organic layer emits light when it is de-stimulated.

However, since the organic light-emitting layer of OLED is generally manufactured by evaporation with a mask, which forms an organic light-emitting layer by a mask plate, the organic light-emitting layer can't be deposited in a small area due to the precision of the mask plate. That is to say, the area of the pixel electrode formed by the mask plate is too large to meet the requirement of a product having a high display resolution.

### SUMMARY

An embodiment of the present disclosure provides a display apparatus and a method for driving the same, which may implement a display effect in a high resolution.

In order to get the object as mentioned above, the embodiment of thepresent disclosure utilizes the following technical solutions.

In one aspect, the embodiment of the present disclosure provides a display apparatus, comprising a display panel, an light modulator, a first driving module and second driving module, wherein the display panel comprises a plurality of pixels including n virtual pixels; the light modulator is provided at a light outputting side of the display panel and comprises a plurality of light modulation units corresponding to the pixels, and thelight modulation unit comprises n light modulation areas corresponding to the virtual pixels; and one frame of image comprises n pieces of sub-frame images;

The first driving module is configured to drive the display panel to display n continuous sub-frame images in one frame of image in turn;

The second driving module is configured to drive the n^{th} light modulation area of the light modulation unit to be a light transmitted region in the n^{th} sub-frame image in turn, and to drive the remaining (n-1) light modulation areas to be a light shielding region, in which N is a positive integer larger than or equal to 2. The present embodiment is not limited to such a correspondence. For example, the second driving module may drive the m^{th} light modulation area of the light modulation unit to be a light transmitted region in the n^{th} sub-frame image in turn, and to drive the remaining (n-1) light modulation areas to be a light shielding region, in which m is a positive integer less than or equal to n.

In another aspect, the embodiment of the present disclosure provides a method for driving a display apparatus, which comprises the following steps:

Driving the display panel to display the n^{th} continuous sub-frame images in one frame of image in turn; and

Driving the n^{th} light modulation area of the light modulation unit to be a light transmitted region in the nth sub-frame image in turn, and to drive the remaining (n-1) light modulation areas to be a light shielding region, in which n is a positive integer larger than or equal to 2.

The embodiment of the present disclosure provides a display apparatus and a method for driving the same. The display panel displays n continuous sub-frame images in one frame of image in turn, and the n^{th} light modulation area of the light modulation unit is driven to be a light transmitted region in the n^{th} sub-frame image in turn, and the remaining (n-1) light modulation areas are driven to be a light shielding region. That is to say, when the display panel displays any one sub-frame image, the light modulation regions of one virtual pixel in the actual pixel is transmitted, so such a virtual pixel displays; and the other virtual pixels do not become an effective pixel since the light modulation regions are shielded. As compared with the prior display technique, one frame of displayed image is divided into a plurality of sub-frame images to be displayed, so that the user may visually experience an improvement of the display resolution. As compared with a conventional method in which the manufacturing process of the display panel is changed by decreasing the area of the pixels to enhance the display resolution, the embodiment of the present disclosure may enhance the visual display resolution without modifying the method for manufacturing the display panel, which greatly decrease the process difficulty and the cost for implementing the high resolution.

### BRIEF DESCRIPTION OF THE DRAWINGS

In order to illustrate the technical solutions of the embodiment of the present disclosure or the prior art, the accompany figures will be simply introduced. It is obvious the following figures only show some embodiments of the present disclosure and those skilled in the art may obtain other figures according to these figures without any inventive labors.

FIG. 1 is a schematic view of a display apparatus according to an embodiment of the present disclosure;

FIG. 2 is a schematic view of the display apparatus as shown in FIG. 1 along a line A-A′;

FIG. 3 is a schematic view of an arrangement of pixels in a display panel according to an embodiment of the present disclosure;

FIG. 4 is a schematic view of an light modulation unit corresponding to the pixels as shown in FIG. 3 according to an embodiment of the present disclosure;

FIG. 5 is a schematic view of driving process of an display apparatus according to an embodiment of the present disclosure;

FIG. 6 is a schematic view of an arrangement of pixels in a display panel according to an embodiment of the present disclosure;

FIG. 7 is a schematic view of an light modulation unit corresponding to the pixels as shown in FIG. 6 according to an embodiment of the present disclosure;

FIG. 8 is a schematic view of driving process of an display apparatus according to another embodiment of the present disclosure;

FIG. 9 is a schematic view of driving process of an display apparatus according to a further embodiment of the present disclosure;

FIG. 9 is a schematic view of driving process of an display apparatus according to a further embodiment of the present disclosure;

FIG. 10 is a schematic view of driving process of an display apparatus according to a further embodiment of the present disclosure;

FIG. 11 is a schematic view of driving process of an display apparatus according to a further embodiment of the present disclosure.

### Reference Signs

10-display panel; 11-pixel; 111-first virtual pixel; 112-second virtual pixel; 20-light modulator; 21-light modulation unit; 22-strip light valve; 211-first light modulation area ; 212-second light modulation area ; 30-first driving module ; 40-second driving module; 100-display apparatus>

### DETAILED DESCRIPTION

The technical solutions of embodiments of the present disclosure would be illustrated in detail and completely in conjunction with the accompany figures. It is obvious that the illustrated embodiments are not all of the embodiments, but are only some embodiments of the present disclosure. On the basis of the embodiments of the disclosure, those skilled in the art may obtain all of the other embodiments without any inventive labors, which belong to the scope of the present disclosure.

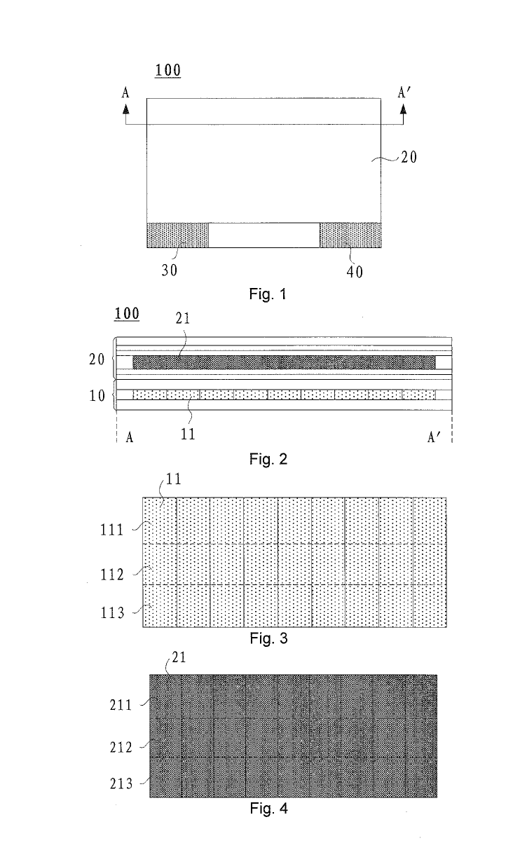

The embodiment of the present disclosure provides a display apparatus 100. As shown in FIG. 1 and FIG. 2, the display apparatus 100comprises a display panel 10, a light modulator 20, a first driving module 30 and a second driving module 40, wherein the display panel 10 comprises a plurality of pixels 11. Each of the pixels includes n virtual pixels. The light modulator 20 is provided at a light outputting side of the display panel 10 and comprises a plurality of light modulation units 21 corresponding to the pixels 11. Each of the light modulation unit 21 comprises n light modulation areas corresponding to the virtual pixels; and one frame of image comprises n pieces of sub-frame images. The first driving module is configured to drive the display panel to display n continuous sub-frame images in one frame of image in turn. The second driving module is configured to drive the n^{th} light modulation area of the light modulation unit to be a light transmitted region in the n^{th} sub-frame image in turn, and to drive the remaining (n-1) light modulation areas to be a light shielding region, in which n is a positive integer larger than or equal to 2.

It should be noted that the display panel and the light modulation unit both comprises a multiple-layer thin film and a stack structure, the embodiment of the present disclosure does not limit the particular structure of the display panel and the light modulation unit. The pixels and the light modulation units in FIG. 2 are only illustrated for an example. Each of the pixels may be a pixel with different colors such as red, green and blue, and three red, green and blue pixels constitutes one pixel unit. It is certain that the pixel unit may comprise four pixels with different colors such as red, green, blue and white or red, green, blue and yellow. The embodiment of the present disclosure does not limit the color, shape and arrangement of the pixels. In particular, the first driving module and the second driving module may be the same module which implements various functions.

They may be different driving modules which implement the respective functions. For example, it is illustrated in FIG. 1 that the first driving module 30 and the second driving module 40 are two different driving modules. It should be noted that although the first driving module and the second driving module have different functions, for the display apparatus, the first driving module and the second driving module have to drive cooperatively, so that n light modulation regions in the light modulation unit are driven to be a light transmitted region in the n sub-frame images in turn and the remaining light modulation regions are driven to be light shielding region.

In the embodiment of the present disclosure, each of the pixels comprises n virtual pixels and the light modulation unit comprises n light modulation regions corresponding to the virtual pixels. Correspondingly, one frame of image comprises n pieces sub-frame images in which the image information on the display panel are different from each other. That is to say, in n pieces of continuous sub-frame images, the image information for each of the sub-frame is generally different, so that the respective effective virtual pixels display different images, which further enhance the fineness of the displayed images.

The display panel comprises a plurality of pixels, and the light modulator comprises light modulation units corresponding to the pixels. Herein, the light modulation unit may correspond to the pixel in a one-to-one correspondence, and one light modulation may correspond to a plurality of pixels. In the following example, it would be illustrated by an example in which the light modulation unit may correspond to the pixel in a one-to-one correspondence. It should be noted that the virtual pixel refers to a part of geometric area of the pixel and it does not need to be one half of the pixel. Only when the pixel comprises two virtual pixels, the virtual pixel may be one half of the pixel. The pixel may comprise n virtual pixels, and the light modulation unit may comprise a light modulation regions corresponding to the virtual pixels. The first driving module is configured to drive the display panel to display n continuous sub-frame images in one frame of image in turn; the second driving module is configured to drive the n^{th} light modulation area of the light modulation unit to be a light transmitted region in the n^{th} sub-frame image in turn, and to drive the remaining (n-1) light modulation areas to be a light shielding region, in which N is a positive integer larger than or equal to 2. That is to say, n may be 2, 3, 4 and so on.

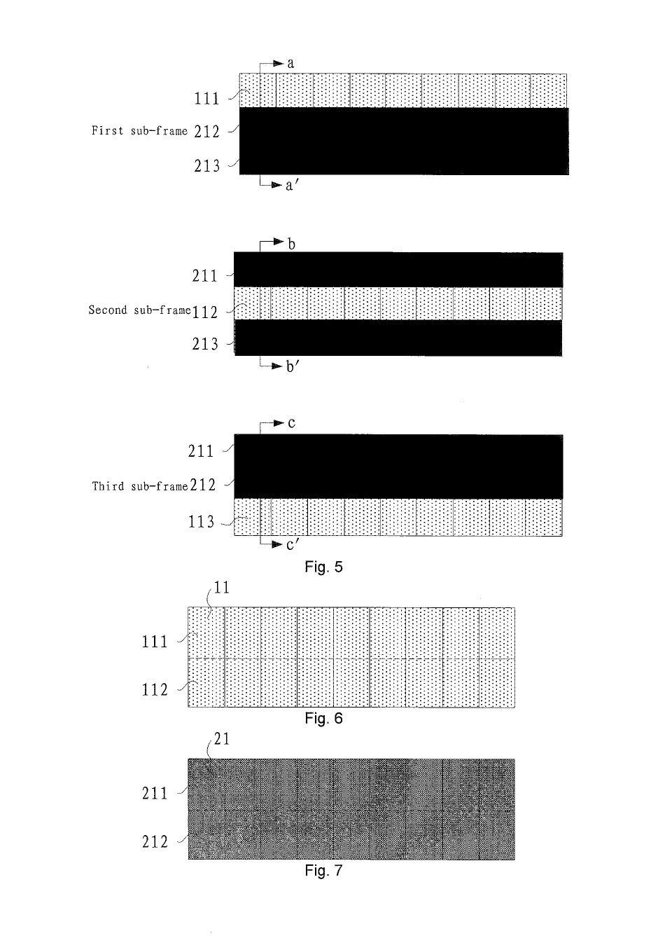

In particular, for example, n may be equal to 3. As shown in FIG. 3, the pixel 11 comprises three virtual pixels, i.e. the first virtual pixel 111, the second virtual pixel 112 and the third virtual pixel 113. As shown in FIG. 4, the light modulation unit 21 comprises three light modulation regions corresponding to the three virtual pixels of the pixel, i.e. the first light modulation area 211, the second light modulation area 212 and the third light modulation area 213. One frame of image comprises three sub-frames images, so when the first driving module drives the display panel to display three continuous sub-frames images in one frame of image in turn, among the three virtual pixels in the light modulation unit, only one of them is light-transmitted and the other two are light shielded in each of the sub-frame. In particular, as shown in FIG. 5, when the display panel displays the first sub-frame image in one frame of image, the first light modulation area corresponding to the first virtual pixel 111 is light-transmitted, and the second light modulation area 212 and the third light modulation area 213 are light-shielded; when the display panel displays the second sub-frame image, the second light modulation area corresponding to the second virtual pixel 112 is light-transmitted, and the first light modulation area 211 and the third light modulation area 213 are light-shielded; and when the display panel displays the third sub-frame image, the third light modulation area corresponding to the third virtual pixel 113 is light-transmitted, and the first light modulation area 211 and the second light modulation area 212 are light-shielded.

It should be illustrated that the driving frequency of the prior display panel is 60 Hz, i.e. 60 frames of images are displayed for one second. Since one pixel in the prior art is a completely effective pixel for one frame of image, i.e. the displaying time for one frame of image is 1/60 second; if the pixel comprises three virtual pixels, the driving frequency of the display panel may be 180 Hz, i.e. 180 frames of images are display for one second. The displaying time for one sub-frame of image is 1/180 second, and the displaying time for one frame of image is still 1/60 second.

In the embodiment of the present disclosure, when one sub-frame of image is displayed, the light modulation region corresponding to one of the virtual pixels for the pixel is driven to be light transmitted, so such a virtual pixel is implemented for displaying; and the other virtual pixels do not become effective pixels since the corresponding light modulation regions are light-shielded. As compared with the prior display technique, one frame of displayed image is divided into a plurality of sub-frame images to be displayed, so that the user may visually experience an improvement of the display resolution. As compared with a conventional method in which the manufacturing process of the display panel is changed by decreasing the area of the pixels to enhance the display resolution, the embodiment of the present disclosure may enhance the visual display resolution without modifying the method for manufacturing the display panel, which greatly decrease the process difficulty and the cost for implementing the high resolution.

In the embodiment of the present disclosure, the display panel may be a display panel of liquid crystal, a display panel of organic light emitting diode, display panel of electronic paper and the like. Since the display panel of organic light-emitting diode is generally manufactured by evaporation with a mask, the area of the pixel itself is larger and can't meet the requirement of high resolution. Preferably, if the display panel is the display panel of organic light emitting diode, it may avoid issues of complex manufacturing process for the display panel of organic light-emitting diode with a high resolution.

Furthermore, the display panel of the organic light emitting diode is a double-side display panel and one light modulator is provided at both sides of the display panel of the organic light emitting diode, respectively. The image displayed by the double-side display panel may meet the requirement of high resolution. Certainly, the display panel of the organic light emitting diode may be a bottom-emitting type of display apparatus, and may be a top-emitting type of display apparatus. The embodiment of the present disclosure does not particularly limit it.

Alternatively, the display panel of the organic light-emitting diode comprises an array substrate and a package substrate, in which the package substrate is a glass substrate or a package film. In particular, the embodiment of the present disclosure does not limit particular package of the display panel of the organic light emitting diode.

Preferably, as shown in FIG. 6, the pixel 11 comprises two virtual pixels, i.e. including the first virtual pixel 111 and the second pixel 112. It should be notated that the positions and sizes of the first virtual pixel and the second virtual pixel in the respective pixel is not constant and FIG. 6 is one example. The embodiment of the present disclosure would be illustrated in detail by taking the embodiment as shown in FIG. 6 as an example. As shown in FIG. 7, the light modulation unit comprises two light modulation regions corresponding to the virtual pixels, i.e. the light modulation unit 21 comprises the first light modulation area 211 and the second light modulation area 212. The first light modulation area 211 corresponds to the first virtual pixel 111, and the second light modulation area 212 corresponds to the second virtual pixel 112. Of course, the first light modulation area may correspond to the second virtual pixel, and the second light modulation area may correspond to the first virtual pixel. The embodiment of the present disclosure would be illustrated in detail by taking an example in which the first light modulation area corresponds to the first virtual pixel and the second light modulation area corresponds to the second virtual pixel.

Correspondingly, one frame of image comprises two sub-frames of images. When the first driving module drives the display panel to display the first sub-frame images in one frame of image, the second driving module is particularly configured to drive the two light modulation areas of the light modulation unit to be a light transmitted region and a light shielding region, respectively. When the first driving module drives the display panel to display the second sub-frame images in one frame of image, the second driving module is particularly configured to drive the respective light modulation areas of the light modulation unit to be a light shielding region and a light transmitted region, respectively, which is opposite to the property of light transmission of the light modulation region when the display panel displays the first sub-frame of image.

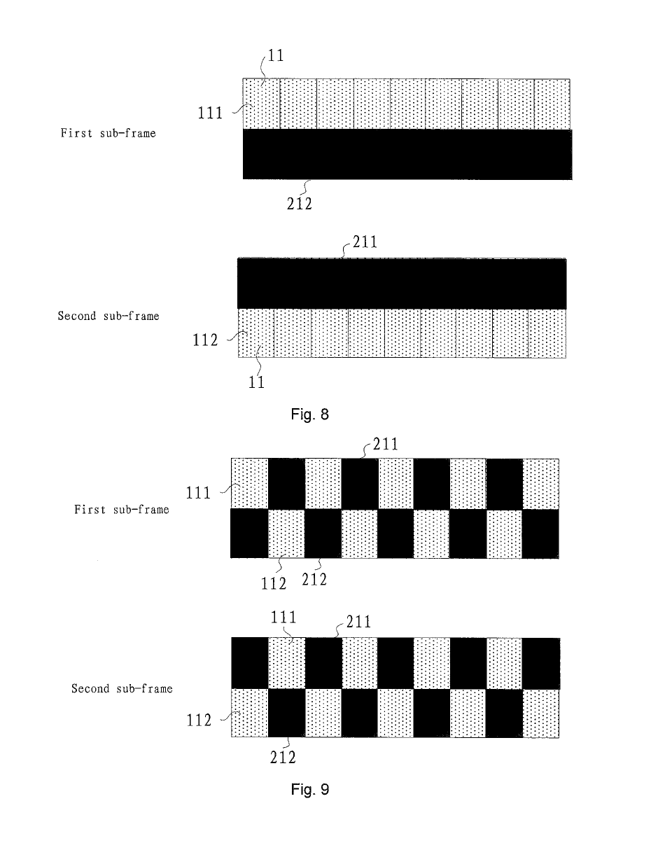

In particularly, as shown in FIG. 8, when the first driving module drives the display panel 10 to display the first sub-frame images in one frame of image, the second driving module drives the first light modulation area 211 of the light modulation unit 21 to be a light transmitted region and drives the second light modulation area 212 to be a light shielding region. When the first driving module 30 drives the display panel 10 to display the second sub-frame images in one frame of image, the second driving module 40 drives the first light modulation area 211 of the light modulation unit 21 to be a light shielding region and drives the second light modulation are 212 to be a light transmitted region. At this moment, the driving frequency of the display panel may be 120 Hz. One frame of image may be doubled in speed by two pieces of sub-frames of images to be displayed, so that the user may visually experience the enhancement of the display resolution.

Alternatively, the virtual pixels of the display panel can be arranged in an array. As shown in FIG. 6, the first virtual pixel 111 and the second virtual pixel 112 are arranged in an array. When the first driving module drives the display panel to display the first sub-frame images in one frame of image, the second driving module particularly drives any two adjacent light modulation areas in one row/column alternatively to be the light transmitted region and the light shielding region.

In particular, if the light modulator comprises a strip light valve provided at each row of the light modulation regions, i.e. one light modulation unit corresponds to the strip light valve for one row of the virtual pixels, the one strip light valve controls one row of light modulation regions to be light transmitted or light shielded. As shown in FIG. 8, by taking an example in which the light modulation unit comprises two light modulation regions, when the first driving module drives the display panel to display the first sub-frame images in one frame of image, the second driving module drives any one row of light modulation regions to be light transmitted and drive the adjacent row of light modulation regions to be light shielded. At this moment, the light transmission property of the same row of light modulation regions are identical, and the light transmission property of any two adjacent rows of light modulation regions are opposite, so any two adjacent light modulation regions in each column are light transmitted region and light shielded region, respectively.

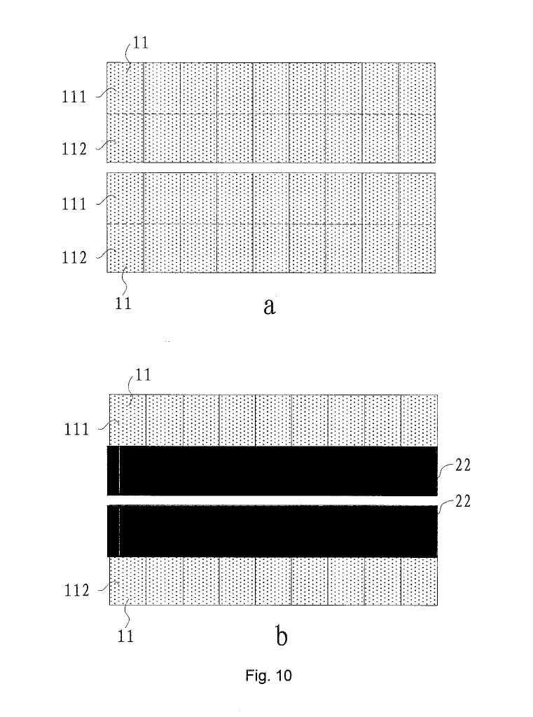

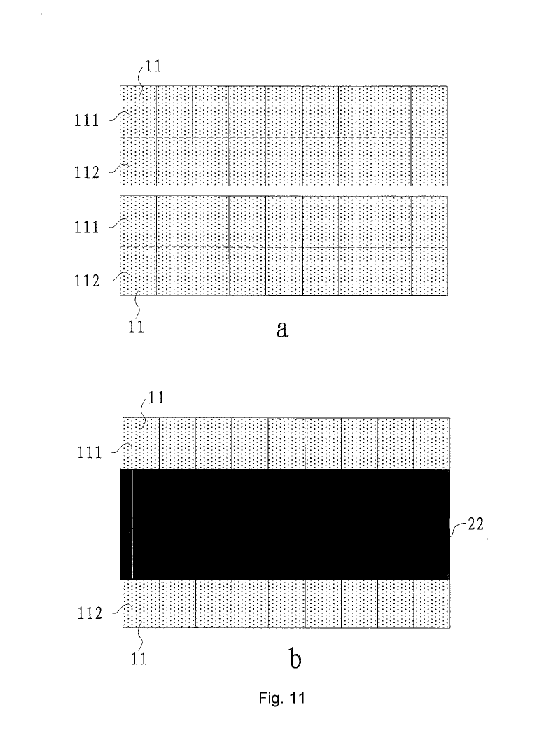

Furthermore, when the light modulator comprises strip light valves 22 at each row of the light modulation regions, as shown in FIG. 10, two strip light valves are utilized to make two adjacent rows of light modulation regions in the two adjacent rows of pixels (corresponding to the two strip light valves 22) be light shielded region. FIG. 10a is a schematic view of the two adjacent rows of pixels, i.e. comprising four adjacent rows of virtual pixels, and FIG. 10b is a schematic view in which the two adjacent rows of light modulation regions in the two adjacent rows of pixels are both light shielded regions, i.e. the two strip light valves control the two adjacent rows of light modulation regions in the two adjacent pixels, respectively. In addition, as shown in FIG. 11, one strip light valve 22 may correspond to the two adjacent light modulation regions in the two adjacent virtual pixels, i.e. one strip light valve controls two rows of light modulation regions so that the two adjacent light modulation regions in the two adjacent rows of pixels (i.e. corresponding to one strip light valve 22) are both light shielded regions.

In particular, if the light modulator comprises a strip light valve provided at each column of the virtual pixels, i.e. one light modulation unit corresponds to the strip light valve for one column of the light modulation region, the one strip light valve controls one column of light modulation regions to be light transmitted or light shielded. As shown in FIG. 10, when the first driving module drives the display panel to display the first sub-frame images in one frame of image, the second driving module drives any one column of light modulation regions to be light transmitted and drive the adjacent column of light modulation regions to be light shielded. At this moment, the light transmission property of the same column of light modulation regions are identical, and the light transmission property of any two adjacent columns of light modulation regions are opposite, so any two adjacent light modulation regions in each row are light transmitted region and light shielded region, respectively. If the light modulator comprises a strip light valve provided at each column of light modulation regions, the two adjacent columns of light modulation regions in the two adjacent columns of pixels may both be light shielded regions. In addition, as shown in FIG. 11, the strip light valve corresponds to two adjacent light modulation regions in the adjacent column of pixels.

Furthermore, when the light modulator comprises strip light valves at each of the light modulation regions, if the light modulation unit corresponds to the virtual pixel in one-to-one correspondence, each of the light modulation units controls light-transmission or light-shielding by one light valve controller, so as to control any virtual pixels in the display panel to display or not display an image. If the light modulator comprises valves provided at each of the light modulation regions, each of the light valves can be controlled to let any two adjacent virtual pixels to be light transmitted region and light shielded region, respectively, as shown in FIG. 9. That is to say, any two adjacent light modulation regions at each row and any two adjacent light modulation regions at each column are light transmitted region and light shielded region, respectively, to visually competent in space to enhance the displaying effect. FIG. 9 shows an example in which the pixel comprises two virtual pixels.

Alternatively, the light valve may be a liquid crystal light valve, a MEMS (Micro-electromechanical Systems) light valve or an electronic paper light valve. In particular, the embodiment of the present disclosure does not limit the particular configuration of the light valves. It should be noted that if the light valve is a liquid crystal light valve, i.e. the light modulator is a liquid crystal light modulator including an upper substrate, a lower substrate and liquid crystal sandwiched between the upper substrate and the lower substrate, the light modulation unit may be controlled to be light transmitted or light shielded by providing an electrode to control the deflection of the liquid crystal, the principle of which is similar to that of the existing liquid crystal display apparatus, as long as it may implement the function of light transmitting and light shielding. The principle of the electronic paper light valve is similar to that of an existing electronic paper, and the principle of the MEMS light valve can refer to the prior art, which is not further illustrated for conciseness.

Alternatively, the display apparatus further comprises a touch electrode for detecting a touch position. In the embodiment of the present disclosure, the display apparatus is a touch display apparatus, which may control displaying of image by the display panel according to a touch control signal. In particular, the touch electrode may comprises a sensor electrode and a touch driving electrode, and the shape and configuration of the touch electrode may refer to the existing display apparatus, which is not further illustrated for conciseness.

Since the light modulator is provided at the light outputting side of the display panel, in order to enhance the sensing of the touch signal, preferably, the touch electrode is provided on the light modulator.

In particular, since the light valve may be a liquid crystal light valve, a MEMS light valve or an electronic paper light valve, i.e. the light modulator may be a liquid crystal light modulator, a MEMS light modulator or an electronic paper light modulator, there are different configurations for providing the touch electrode on the light modulator according to particular situations. By taking the liquid crystal light modulator as an example, the liquid crystal light modulator may comprise an upper substrate, a lower substrate and liquid crystal sandwiched between the upper substrate and the lower substrate, in which the touch electrode and the sensing electrode may be both provided on the upper substrate, may be both provided on the lower substrate, or may be provided on the upper substrate and the lower substrate, respectively. The embodiment of the present disclosure does not limit the particular configuration in which the touch electrode and the sensing electrode are provided on the light modulator, and the embodiment is illustrated by taking the above mentioned configuration as an example.

In particular, if the light valve is a liquid crystal light valve, the first polarizer and the second polarizer are provided on the upper substrate and the lower substrate of the liquid crystal light modulator, respectively. In the following, the method for manufacturing a display apparatus according to the embodiment of the present disclosure will be illustrated in detail by taking an example in which the grating is a liquid crystal grating and the display panel is a display panel of an organic light emitting diode.

At step 10, the display panel of an organic light emitting diode is formed.

In particular, the step 10 as mentioned particularly comprises the following steps: a transparent substrate is rinsed by a standard cleaning method; a metal layer is deposited (Mo layer with a thickness of about 200 nm is deposited); the metal layer is patterned to form a gate metal layer and form corresponding patterns including a gate and a gate line; an insulation layer is deposited (SiO₂ layer with a thickness of about 150 nm may be deposited); a semiconductor layer is deposited (IGZO with a thickness of about 40 nm may be deposited) and is patterned to form an active layer; a metal layer is deposited (Mo layer with a thickness of about 200 nm is deposited) and is patterned to form source/drain metal layer including source, drain and data lines; passivation layer is deposited (SiO₂ layer with a thickness of about 300 nm may be deposited); a pixel electrode is deposited (ITO layer with a thickness of about 40 nm may be deposited) and patterned; finally, PMMA-group material is spin coated, photolithography etched and solidified to be a pixel boundary layer with a thickness of about 1.5 um. Thus, pixels in an array are formed on the transparent substrate.

Plasma is utilized to process the surface of the pixel; organic material is thermally evaporated in an OLED/EL-organic metal film deposition high-vacuum system (evaporating to form a hole injection layer, a hole transport layer, a light emitting layer, an electron transport layer and an electron injection layer in turn), the total thickness of which is 100-300 nm. Then, a cathode metal layer is evaporated. The cathode layer may be a LiF:Al layer with a thickness of 500-1000 nm. After the evaporating is completed, packaging and slicing are implemented to achieve the organic light emitting diode display panel. Herein, the LiF:Al layer is a LiF film deposited on an Al film, in which the thickness of the LiF film is about 0.8 nm. The LiF film is mainly used to enhance electron injection.

At step 20, a liquid crystal light modulator is formed.

In particular, the step 20 as mentioned above comprises the following steps: the lower substrate is rinsed by a standard cleaning method; a metal layer of Mo with a thickness of about 200 nm is deposited and patterned to form a corresponding pattern; an insulation layer is deposited (SiO₂ layer with a thickness of about 150 nm may be deposited); a pixel electrode is deposited (ITO layer with a thickness of about 60 nm may be deposited); after the upper substrate is rinsed by a standard cleaning method, a common electrode is deposited (ITO layer with a thickness of about 60 nm may be deposited); then an orientation friction is applied to the upper and lower substrates and the liquid crystal is injected between the upper and lower substrates, and the upper and lower substrates are adhered to each other and sliced to form the liquid crystal light modulator.

At step 30, the display panel of organic light emitting diode is adhered to the liquid crystal light modulator, and they are bonded to a circuit.

The polarizers are adhered to the opposite sides of the liquid crystal light modulator; the display panel of the organic light emitting diode and the liquid crystal light modulator are aligned and fit to each other according to the corresponding aligned pattern of the display panel of the organic light emitting diode and the liquid crystal light modulator; and a flexible circuit board such as a driver circuit and the like is bonded and the program is debug to form a finally complete module.

It should be noted that there are various types and manufacturing method for the display panel of the organic light emitting diode and the liquid crystal light modulator, and the embodiment of the present disclosure only takes the manufacturing method as mentioned above as an example for illustration. The embodiment of the present disclosure will not list the other types of display panels and liquid crystal light modulator.

The embodiment of the present disclosure provides a method for driving a display apparatus, comprising the following steps.

The display panel is driven to display the n continuous sub-frame images in one frame of image in turn.

The n^{th} light modulation area of the light modulation unit are driven to be a light transmitted region in the n^{th} sub-frame image in turn, and to drive the remaining (n-1) light modulation areas are driven to be a light shielding region, in which n is a positive integer larger than or equal to 2.

In particular, the display apparatus may utilize the first driving module to drive the display panel to display n continuous sub-frame images in one frame of image in turn, utilizes the second driving module to drive the n^{th} light modulation area of the light modulation unit to be a light transmitted region in the n^{th} sub-frame image in turn, and to drive the remaining light modulation areas to be a light shielding region. In particular, the first driving module and the second driving module may be the same module which implements various functions. They may be different driving modules which implement the respective functions. For example, it is illustrated in FIG. 1 that the first driving module 30 and the second driving module 40 are two different driving modules. It should be noted that although the first driving module and the second driving module have different functions, for the display apparatus, the first driving module and the second driving module have to drive cooperatively, so that n light modulation regions in the light modulation unit are driven to be a light transmitted region in the n sub-frame images in turn and the remaining (n-1) light modulation regions are driven to be light shielding region.

In particular, for example, n may be equal to 3. As shown in FIG. 3, the pixel 11 comprises three virtual pixels, i.e. the first virtual pixel 111, the second virtual pixel 112 and the third virtual pixel 113. As shown in FIG. 4, the light modulation unit 21 comprises three light modulation regions corresponding to the three virtual pixels of the pixel, i.e. the first light modulation area 211, the second light modulation area 212 and the third light modulation area 213. One frame of image comprises three sub-frames images, so when the first driving module drives the display panel to display three continuous sub-frames images in one frame of image in turn, among the three virtual pixels in the light modulation unit, only one of them is light-transmitted and the other two are light shielded in each of the sub-frame. In particular, as shown in FIG. 5, when the display panel displays the first sub-frame image in one frame of image, the first light modulation area corresponding to the first virtual pixel 111 is light-transmitted, and the second light modulation area 212 and the third light modulation area 213 are light-shielded; when the display panel displays the second sub-frame image, the second light modulation area corresponding to the second virtual pixel 112 is light-transmitted, and the first light modulation area 211 and the third light modulation area 213 are light-shielded; and when the display panel displays the third sub-frame image, the third light modulation area corresponding to the third virtual pixel 113 is light-transmitted, and the first light modulation area 211 and the second light modulation area 212 are light-shielded.

It should be illustrated that the driving frequency of the prior display panel is 60 Hz, i.e. 60 frames of images are displayed for one second. Since one pixel in the prior art is a completely effective pixel for one frame of image, i.e. the displaying time for one frame of image is 1/60 second; if the pixel comprises three virtual pixels, the driving frequency of the display panel may be 180 Hz, i.e. 180 frames of images are display for one second. The displaying time for one sub-frame of image is 1/180 second, and the displaying time for one frame of image is still 1/60 second.

In the embodiment of the present disclosure, when one sub-frame of image is displayed, the light modulation region corresponding to one of the virtual pixels for the pixel is driven to be light transmitted, so such a virtual pixel is implemented for displaying; and the other virtual pixels do not become effective pixels since the corresponding light modulation regions are light-shielded. As compared with the prior display technique, one frame of displayed image is divided into a plurality of sub-frame images to be displayed, so that the user may visually experience an improvement of the display resolution. As compared with a conventional method in which the manufacturing process of the display panel is changed by decreasing the area of the pixels to enhance the display resolution, the embodiment of the present disclosure may enhance the visual display resolution without modifying the method for manufacturing the display panel, which greatly decrease the process difficulty and the cost for implementing the high resolution.

Alternatively, the pixel comprise two virtual pixels, and one frame of image comprises two pieces of sub-frame images; the light modulation unit comprises two light modulation areas corresponding to the virtual pixels, respectively; wherein the step of driving the display panel to display the n continuous sub-frame images in one frame of image in turn and driving the n^{th} light modulation area of the light modulation unit to be a light transmitted region in the n^{th} sub-frame image in turn, and driving the remaining (n-1) light modulation areas to be a light shielding region, in which N is a positive integer larger than or equal to 2, is particularly implemented by the following steps.

When the display panel is driven to display the first sub-frame images in one frame of image, the two light modulation areas of the light modulation unit are driven alternatively to be the light transmitted region and the light shielding region.

When the display panel is driven to display the second sub-frame images in the one frame of image, the light transparency of the respective light modulation areas of the light modulation unit is driven to be opposite to those of the light modulation regions when the first sub-frame image is displayed.

As shown in FIG. 6, the pixel 11 comprises two virtual pixels, i.e. including the first virtual pixel 111 and the second pixel 112. It should be notated that the positions and sizes of the first virtual pixel and the second virtual pixel in the respective pixel is not constant and FIG. 6 is one example. The embodiment of the present disclosure would be illustrated in detail by taking the embodiment as shown in FIG. 6 as an example. As shown in FIG. 7, the light modulation unit comprises two light modulation regions corresponding to the virtual pixels, i.e. the light modulation unit 21 comprises the first light modulation area 211 and the second light modulation area 212. The first light modulation area 211 corresponds to the first virtual pixel 111, and the second light modulation area 212 corresponds to the second virtual pixel 112.

As shown in FIG. 8, when the first driving module drives the display panel 10 to display the first sub-frame images in one frame of image, the second driving module drives the first light modulation area 211 of the light modulation unit 21 to be a light transmitted region and drives the second light modulation area 212 to be a light shielding region. When the first driving module 30 drives the display panel 10 to display the second sub-frame images in one frame of image, the second driving module 40 drives the first light modulation area 211 of the light modulation unit 21 to be a light shielding region and drives the second light modulation are 212 to be a light transmitted region. At this moment, the driving frequency of the display panel may be 120 Hz. One frame of image may be doubled in speed by two pieces of sub-frames of images to be displayed, so that the user may visually experience the enhancement of the display resolution.

Alternatively, the virtual pixels of the display panel can be arranged in an array. When the first driving module drives the display panel to display the first sub-frame images in one frame of image, the second driving module particularly drives any two adjacent light modulation areas in one row/column alternatively to be the light transmitted region and the light shielding region.

In particular, if the light modulator comprises a strip light valve provided at each row of the light modulation regions, i.e. one light modulation unit corresponds to the strip light valve for one row of the virtual pixels, the one strip light valve controls one row of light modulation regions to be light transmitted or light shielded. As shown in FIG. 8, by taking an example in which the light modulation unit comprises two light modulation regions, when the first driving module drives the display panel to display the first sub-frame images in one frame of image, the second driving module drives any one row of light modulation regions to be light transmitted and drive the adjacent row of light modulation regions to be light shielded. At this moment, the light transmission property of the same row of light modulation regions are identical, and the light transmission property of any two adjacent rows of light modulation regions are opposite, so any two adjacent light modulation regions in each column are light transmitted region and light shielded region, respectively.

Furthermore, when the light modulator comprises strip light valves 22 at each row of the light modulation regions, as shown in FIG. 10, two strip light valves are utilized to make two adjacent rows of light modulation regions in the two adjacent rows of pixels (corresponding to the two strip light valves 22) be light shielded region. FIG. 10a is a schematic view of the two adjacent rows of pixels, i.e. comprising four adjacent rows of virtual pixels, and FIG. 10b is a schematic view in which the two adjacent rows of light modulation regions in the two adjacent rows of pixels are both light shielded regions, i.e. the two strip light valves control the two adjacent rows of light modulation regions in the two adjacent pixels, respectively. In addition, as shown in FIG. 11, one strip light valve 22 may correspond to the two adjacent light modulation regions in the two adjacent virtual pixels, i.e. one strip light valve controls two rows of light modulation regions so that the two adjacent light modulation regions in the two adjacent rows of pixels (i.e. corresponding to one strip light valve 22) are both light shielded regions.

If the light modulator comprises a strip light valve provided at each column of the virtual pixels, i.e. one light modulation unit corresponds to the strip light valve for one column of the light modulation region, the one strip light valve controls one column of light modulation regions to be light transmitted or light shielded. As shown in FIG. 10, when the first driving module drives the display panel to display the first sub-frame images in one frame of image, the second driving module drives any one column of light modulation regions to be light transmitted and drive the adjacent column of light modulation regions to be light shielded. At this moment, the light transmission property of the same column of light modulation regions are identical, and the light transmission property of any two adjacent columns of light modulation regions are opposite, so any two adjacent light modulation regions in each row are light transmitted region and light shielded region, respectively. If the light modulator comprises a strip light valve provided at each column of light modulation regions, the two adjacent columns of light modulation regions in the two adjacent columns of pixels may both be light shielded regions. In addition, as shown in FIG. 11, the strip light valve corresponds to two adjacent light modulation regions in the adjacent column of pixels.

Furthermore, when the light modulator comprises strip light valves at each of the light modulation regions, if the light modulation unit corresponds to the virtual pixel in one-to-one correspondence, each of the light modulation units controls light-transmission or light-shielding by one light valve controller, so as to control any virtual pixels in the display panel to display or not display an image. If the light modulator comprises valves provided at each of the light modulation regions, each of the light valves can be controlled to let any two adjacent virtual pixels to be light transmitted region and light shielded region, respectively, as shown in FIG. 9. That is to say, any two adjacent light modulation regions at each row and any two adjacent light modulation regions at each column are light transmitted region and light shielded region, respectively, to visually competent in space to enhance the displaying effect. FIG. 9 shows an example in which the pixel comprises two virtual pixels.

The above mentioned descriptions only show particular implementations of the present invention and the present invention is not limited to it. Any modifications or alternatives which are appreciated for those skilled in the art based on the contents disclosed by the present invention may fall within the scope of the present invention. Thus, the scope of the present invention is defined by the accompany claims.

1. A display apparatus, comprising a display panel, an light modulator, a first driving module and second driving module, wherein the display panel comprises a plurality of pixels including n virtual pixels; the light modulator is provided at a light outputting side of the display panel and comprises a plurality of light modulation units corresponding to the pixels, and the light modulation unit comprises n light modulation areas corresponding to the virtual pixels; and one frame of image comprises n pieces of sub-frame images;
the first driving module is configured to drive the display panel to display n continuous sub-frame images in one frame of image in turn; and
the second driving module is configured to drive the n^{th} light modulation area of the light modulation unit to be a light transmitted region in the n^{th} sub-frame image in turn, and to drive the remaining (n-1) light modulation areas to be a light shielding region, in which N is a positive integer larger than or equal to 2.

2. The display apparatus according to claim 1, wherein the pixel comprise two virtual pixels, the light modulation unit comprises two light modulation areas corresponding to the virtual pixels, respectively, and one frame of image comprises two pieces of sub-frame images;
the first driving module drives the display panel to display the first sub-frame images in one frame of image, and the second driving module drives the two light modulation areas of the light modulation unit alternatively to be the light transmitted region and the light shielding region;
the first driving module drives the display panel to display the second sub-frame images in the one frame of image, and the second driving module drives the light transparency of the respective light modulation areas of the light modulation unit to be opposite to those of the light modulation regions when the first sub-frame image is displayed.

3. The display apparatus according to claim 2, wherein the virtual pixels of the display panel are arranged in an array;
the first driving module drives the display panel to display the first sub-frame images in one frame of image, and the second driving module drives any two adjacent light modulation areas in one row/column alternatively to be the light transmitted region and the light shielding region.

4. The display apparatus according to claim 1, wherein the light modulator comprises a light valve provide at each of the light modulation regions, and the light valve is configured to control the light modulation region to be light transmitted or light shielding.

5. The display apparatus according to claim 1, wherein the light modulator comprises a strip light valve provided at each row or each column of the light modulation regions; or
The light modulator comprises a strip light valve provided at two adjacent rows or at two adjacent columns of the light modulation regions, wherein the two adjacent rows of the light modulation regions correspond to two corresponding adjacent rows of pixels and the two adjacent columns of the light modulation regions correspond to two corresponding adjacent columns of pixels.

6. The display apparatus according to claim 4, wherein the light valve is a liquid crystal light valve, a MEMS light valve or an electronic paper light valve.

7. The display apparatus according to claim 1, wherein the display apparatus further comprises a touch electrode for detecting a touch position.

8. The display apparatus according to claim 7, wherein the touch electrode is provided on the light modulator.

9. The display apparatus according to claim 8, wherein the light valve is the liquid crystal light valve; the light modulator comprises an upper substrate, a lower substrate and a liquid between the upper substrate and the lower substrate; the touch electrode and the sensing electrode are both provided on the upper substrate, or the touch electrode and the sensing electrode are both provided on the lower substrate, or the touch electrode and the sensing electrode are formed on the upper substrate and the lower substrate, respectively.

10. The display apparatus according to claim 1, wherein the display panel is a display panel of an organic light emitting diode.

11. The display apparatus according to claim 10, wherein the display apparatus of the organic light emitting diode is a double-side display panel and a light modulator is provided at both sides of the display panel of the organic light emitting diode.

12. A method for driving a display apparatus, wherein the display apparatus comprises a display panel, an light modulator, a first drive module and second driving module, wherein the display panel comprises a plurality of pixels including n virtual pixels; the light modulator is provided at a light outputting side of the display panel and comprises a plurality of light modulation units corresponding to the pixels, and the light modulation unit comprises n light modulation areas corresponding to the virtual pixels; and one frame of image comprises n pieces of sub-frame images;
the method for driving the display apparatus comprising the following steps:
driving the display panel to display the n continuous sub-frame images in one frame of image in turn; and
driving the n^{th} light modulation area of the light modulation unit to be a light transmitted region in the n^{th} sub-frame image in turn, and to drive the remaining (n-1) light modulation areas to be a light shielding region, in which N is a positive integer larger than or equal to 2.

13. The method for driving a display apparatus according to claim 12, wherein the pixel comprise two virtual pixels, and one frame of image comprises two pieces of sub-frame images; the light modulation unit comprises two light modulation areas corresponding to the virtual pixels, respectively;
wherein the step of driving the display panel to display the n continuous sub-frame images in one frame of image in turn and driving the n^{th} light modulation area of the light modulation unit to be a light transmitted region in the n^{th} sub-frame image in turn, and driving the remaining (n-1) light modulation areas to be a light shielding region, in which N is a positive integer larger than or equal to 2, is particularly implemented by the following steps of:
when the display panel is driven to display the first sub-frame images in one frame of image, the two light modulation areas of the light modulation unit are driven alternatively to be the light transmitted region and the light shielding region;
when the display panel is driven to display the second sub-frame images in the one frame of image, the light transparency of the respective light modulation areas of the light modulation unit is driven to be opposite to those of the light modulation regions when the first sub-frame image is displayed.

14. The method for driving a display apparatus according to claim 13, wherein the virtual pixels of the display panel are arranged in an array;
when the display panel is driven to display the first sub-frame images in one frame of image, any two adjacent light modulation areas in one row/column are driven alternatively to be the light transmitted region and the light shielding region.

15. The display apparatus according to claim 5, wherein the light valve is a liquid crystal light valve, a MEMS light valve or an electronic paper light valve.

16. The method for driving a display apparatus according to claim 12, further comprising, in the light modulator, proving a light valve provide at each of the light modulation regions, and the light valve is configured to control the light modulation region to be light transmitted or light shielding.

17. The method for driving a display apparatus according to claim 12, further comprising, in the light modulator, providing a strip light valve provided at each row or each column of the light modulation regions; or further comprising, in the light modulator, providing a strip light valve provided at two adjacent rows or at two adjacent columns of the light modulation regions,
wherein the two adjacent rows of the light modulation regions correspond to two corresponding adjacent rows of pixels and the two adjacent columns of the light modulation regions correspond to two corresponding adjacent columns of pixels.

18. The method for driving a display apparatus according to claim 16, wherein the light valve is a liquid crystal light valve, a MEMS light valve or an electronic paper light valve.

19. The method for driving a display apparatus according to claim 17, wherein the light valve is a liquid crystal light valve, a MEMS light valve or an electronic paper light valve.

20. The method for driving a display apparatus according to claim 12, wherein the display apparatus further comprises a touch electrode for detecting a touching position.
